(19) United States
(12) Patent Application Publication
(10) Pub. No.: US 2026/0086840 A1
(43) Pub. Date: Mar. 26, 2026

(54) AUTO SWITCH NODE WITHIN GROUP IN CONNECTIVITY ENABLEMENT

(71) Applicant: Dell Products L.P., Round Rock, TX (US)

(72) Inventors: Xiang HUANG, Shanghai (CN); Yena CHEN, Shanghai (CN)

(73) Assignee: Dell Products L.P., Round Rock, TX (US)

(21) Appl. No.: 18/917,677

(22) Filed: Oct. 16, 2024

(30) Foreign Application Priority Data
Sep. 20, 2024 (CN) 202411316136.3

(51) Int. Cl. G06F 9/455; H04L 41/0895

(52) U.S. Cl. CPC G06F 9/45558; H04L 41/0895; G06F 2009/4557; G06F 2009/45595

(57) ABSTRACT

An information handling system may include at least one processor and a memory. The information handling system may be configured to select a node from a plurality of nodes of an information handling system cluster for establishing secure communication with a backend system by: partitioning the plurality of nodes into a plurality of groups; selecting a first group from the plurality of groups; selecting a node from the first group that includes a connectivity key thereon; attempting to establish connectivity with the backend system via the connectivity key; and in response to a successful connection, altering a priority setting associated with the first group.

### TECHNICAL FIELD

The present disclosure relates in general to information handling systems, and more particularly to ensuring that secure connectivity can be established between a cluster of information handling systems and a manufacturer backend system.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Hyper-converged infrastructure (HCI) is an IT framework that combines storage, computing, and networking into a single system in an effort to reduce data center complexity and increase scalability. Hyper-converged platforms may include a hypervisor for virtualized computing, software-defined storage, and virtualized networking, and they typically run on standard, off-the-shelf servers. One type of HCI solution is the Dell EMC VxRail™ system. Some examples of HCI systems may operate in various environments (e.g., an HCI management system such as the VMware® vSphere® ESXi™ environment, or any other HCI management system). Some examples of HCI systems may operate as software-defined storage (SDS) cluster systems (e.g., an SDS cluster system such as the VMware® vSAN™ system, or any other SDS cluster system).

In the HCI context (as well as other contexts), information handling systems may execute virtual machines (VMs) for various purposes. A VM may generally comprise any program of executable instructions, or aggregation of programs of executable instructions, configured to execute a guest operating system on a hypervisor or host operating system in order to act through or in connection with the hypervisor/host operating system to manage and/or control the allocation and usage of hardware resources such as memory, central processing unit time, disk space, and input and output devices, and provide an interface between such hardware resources and application programs hosted by the guest operating system.

Some HCI systems use a cloud platform manager (e.g., APEX Cloud Platform™ from Dell®) for handling various cloud management tasks. The connectivity between the cloud platform manager of an HCI system and the various manufacturer backend systems is increasingly important. Such backend systems may be used for remote cluster management, installation of updates, adding or removing nodes, etc.

In some cases, the HCI system may use one of its nodes to handle the authentication procedure with the backend systems. This may involve using a pre-generated cryptographic connectivity key that has been bound with that particular node. The connectivity key installed in the node is then used to authenticate and create a secure connection between the cloud platform manager executing on the local cluster and the manufacturer backend. For purposes of this disclosure, the term “connectivity key” refers to any cryptographic key, signature, token, etc. that is usable to establish a secure communications link between one information handling system and another.

In some situations, however, the node holding the connectivity key may be unable to carry out this task. For example, that node might be having a hardware or software issue, or the connectivity key data might be corrupted or expired, etc., causing a failure to establish connectivity with the backend systems. Accordingly, it would be advantageous to be able to automatically switch to a different node to handle connectivity with the backend systems. Embodiments of this disclosure provide improvements in this field.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with establishing connectivity between a cluster and a backend system may be reduced or eliminated.

In accordance with embodiments of the present disclosure, an information handling system may include at least one processor and a memory. The information handling system may be configured to select a node from a plurality of nodes of an information handling system cluster for establishing secure communication with a backend system by: partitioning the plurality of nodes into a plurality of groups; selecting a first group from the plurality of groups; selecting a node from the first group that includes a connectivity key thereon; attempting to establish connectivity with the backend system via the connectivity key; and in response to a successful connection, altering a priority setting associated with the first group.

In accordance with these and other embodiments of the present disclosure, a method for selecting a node from a plurality of nodes of an information handling system cluster for establishing secure communication with a backend system may include: partitioning the plurality of nodes into a plurality of groups; selecting a first group from the plurality of groups; selecting a node from the first group that includes a connectivity key thereon; attempting to establish connectivity with the backend system via the connectivity key; and in response to a successful connection, altering a priority setting associated with the first group.

In accordance with these and other embodiments of the present disclosure, an article of manufacture may include a non-transitory, computer-readable medium having computer-executable instructions thereon that are executable by a processor of an information handling system for: selecting a node from a plurality of nodes of an information handling system cluster for establishing secure communication with a backend system by: partitioning the plurality of nodes into a plurality of groups; selecting a first group from the plurality of groups; selecting a node from the first group that includes a connectivity key thereon; attempting to establish connectivity with the backend system via the connectivity key; and in response to a successful connection, altering a priority setting associated with the first group.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure; and

FIGS. 2-3 illustrate example methods, in accordance with embodiments of the present disclosure.

### DETAILED DESCRIPTION

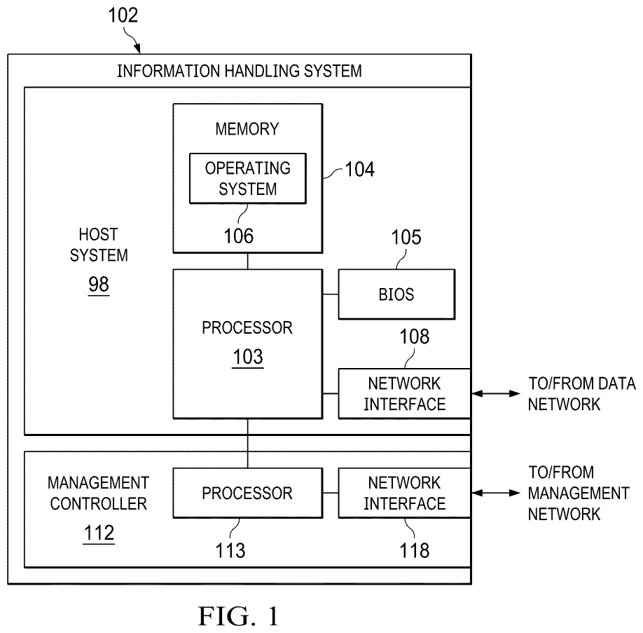

Preferred embodiments and their advantages are best understood by reference to FIGS. 1 through 3, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103, and a management controller 112 communicatively coupled to processor 103.

In operation, processor 103, memory 104, BIOS 105, and network interface 108 may comprise at least a portion of a host system 98 of information handling system 102. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

Management controller 112 may be configured to provide management functionality for the management of information handling system 102. Such management may be made by management controller 112 even if information handling system 102 and/or host system 98 are powered off or powered to a standby state. Management controller 112 may include a processor 113, memory, and a network interface 118 separate from and physically isolated from network interface 108.

As shown in FIG. 1, processor 113 of management controller 112 may be communicatively coupled to processor 103. Such coupling may be via a Universal Serial Bus (USB), System Management Bus (SMBus), and/or one or more other communications channels.

Network interface 118 may be coupled to a management network, which may be separate from and physically isolated from the data network as shown. Network interface 118 of management controller 112 may comprise any suitable system, apparatus, or device operable to serve as an interface between management controller 112 and one or more other information handling systems via an out-of-band management network. Network interface 118 may enable management controller 112 to communicate using any suitable transmission protocol and/or standard. In these and other embodiments, network interface 118 may comprise a network interface card, or “NIC.” Network interface 118 may be the same type of device as network interface 108, or in other embodiments it may be a device of a different type.

As discussed above, information handling system 102 may be a node of an HCI system that is configured to communicatively couple to a remote system such as a manufacturer backend server. Information handling system 102 may thus be provisioned with a cryptographic connectivity key that is tied to its specific hardware and/or firmware and/or software, and which is usable to establish secure communications.

In situations where a given node fails to establish communications for some reason, embodiments of this disclosure provide for automatically switching to a different node within the cluster to establish connectivity with the backend.

In particular, nodes may be grouped according to predefined and/or customized rules. For example, groups may be formed based on any desired criteria, including the model numbers of individual nodes, the number of nodes in a cluster, hardware and/or firmware and/or software differences between the nodes, etc. As a default rule in the absence of customizations, a cluster may be divided equally into a desired number of groups (e.g., with eight nodes per group) by enumerating the nodes in order.

When the connectivity is to be established between the cluster and the backend, an available node with an installed connectivity key may be selected from one group. If the connectivity key installed in the selected node is broken or expired, or if the node is otherwise unable to establish connectivity, then embodiments automatically re-select other nodes within the group to continue attempting to establish connectivity.

In some embodiments, a user may be able to set a desired number of retries for node selection within a group. For large-scale clusters (e.g., those with more than 32 nodes), this may significantly improve the cluster's ability to connect to the backend systems.

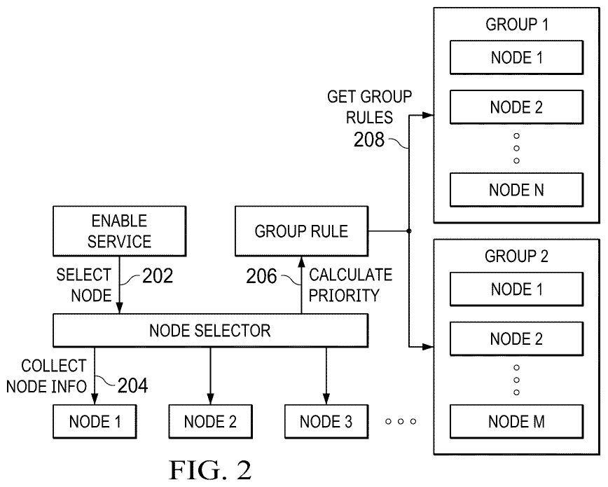

Turning now to FIG. 2, an example method is shown. The method begins when a request is made to enable some service that needs communication with a backend system. Enabling the service in this case requires at least one available node with a connectivity key to establish secure communications.

The method then calls the node selector at step 202. The node selector may collect information from the various nodes at step 204. At steps 206 and 208, the node selector may determine the priority of nodes based on the collected information, the defined group rules, and any other suitable factors.

If the selected node fails to enable connectivity, then the node selector may repeatedly re-select other nodes from the rest of the same group. When the selected node successfully establishes connectivity, then its group may be set as the highest priority of all groups. That group will then be preferred when connectivity is enabled next time.

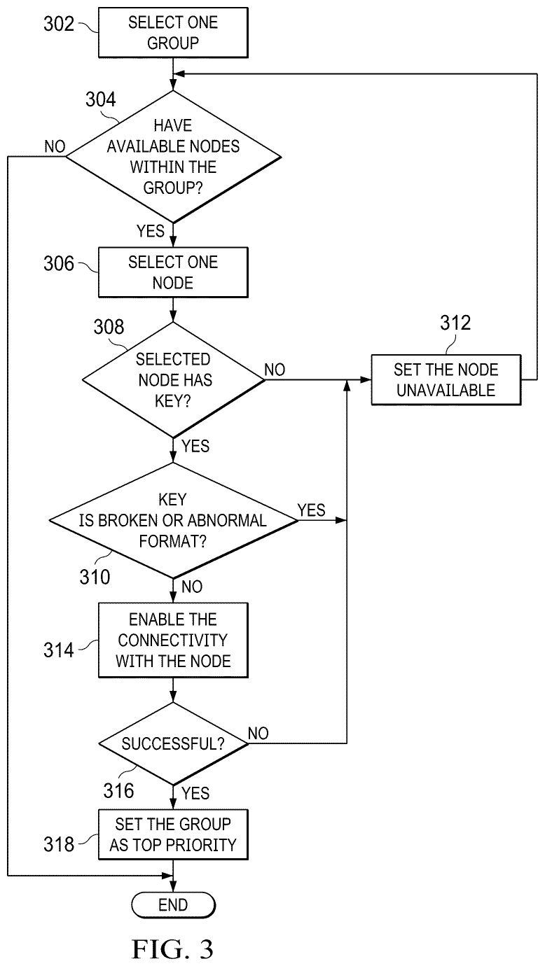

Turning now to FIG. 3, another example method is shown.

At step 302, a group is selected. This selection may be based on prior attempts at communication (for example, the group that was previously used successfully may have a high priority to be used again), or it may be random or pseudorandom in some cases. At step 304, the method determines whether there are any available nodes in the selected group that have not already attempted to establish communications. If not, the method may end (e.g., by returning to step 302 and using a different group).

If there are nodes available, one is selected at step 306 (e.g., randomly or pseudorandomly). If the selected node does not have a connectivity key (or if its key is non-functional for any reason), then it is set to an unavailable status, and the method returns to step 304.

If the connectivity key appears to be functional, then the method proceeds to attempt to establish connectivity with that key at step 314. If this is successful, then the current group may be tagged with the highest priority, to be used first the next time connectivity is needed.

One of ordinary skill in the art with the benefit of this disclosure will understand that the preferred initialization point for the methods depicted in FIGS. 2 and 3 and the order of the steps comprising those methods may depend on the implementation chosen. In these and other embodiments, these methods may be implemented as hardware, firmware, software, applications, functions, libraries, or other instructions. Further, although FIGS. 2 and 3 disclose a particular number of steps to be taken with respect to the disclosed methods, the methods may be executed with greater or fewer steps than depicted. The methods may be implemented using any of the various components disclosed herein (such as the components of FIG. 1), and/or any other system operable to implement the methods.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that a structure is “configured to” or “operable to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]”construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An information handling system comprising:
at least one processor; and
a memory;
wherein the information handling system is configured to select a node from a plurality of nodes of an information handling system cluster for establishing secure communication with a backend system by:
partitioning the plurality of nodes into a plurality of groups;
selecting a first group from the plurality of groups;
selecting a node from the first group that includes a connectivity key thereon;
attempting to establish connectivity with the backend system via the connectivity key; and
in response to a successful connection, altering a priority setting associated with the first group.

2. The information handling system of claim 1, wherein the information handling system cluster is a hyper-converged infrastructure (HCI) system.

3. The information handling system of claim 1, wherein the altered priority setting is configured to cause the first group to be preferred in subsequent attempts to establish connectivity with the backend system.

4. The information handling system of claim 1, wherein partitioning the plurality of nodes into the plurality of groups comprises putting an equal number of nodes into each group.

5. The information handling system of claim 1, wherein partitioning the plurality of nodes into the plurality of groups is based at least in part on customized group rules.

6. The information handling system of claim 1, wherein in response to an unsuccessful connection, the information handling system is configured to select a different node from the first group.

7. A method for selecting a node from a plurality of nodes of an information handling system cluster for establishing secure communication with a backend system by:
partitioning the plurality of nodes into a plurality of groups;
selecting a first group from the plurality of groups;
selecting a node from the first group that includes a connectivity key thereon;
attempting to establish connectivity with the backend system via the connectivity key; and
in response to a successful connection, altering a priority setting associated with the first group.

8. The method of claim 7, wherein the information handling system cluster is a hyper-converged infrastructure (HCI) system.

9. The method of claim 7, wherein the altered priority setting is configured to cause the first group to be preferred in subsequent attempts to establish connectivity with the backend system.

10. The method of claim 7, wherein partitioning the plurality of nodes into the plurality of groups comprises putting an equal number of nodes into each group.

11. The method of claim 7, wherein partitioning the plurality of nodes into the plurality of groups is based at least in part on customized group rules.

12. The method of claim 7, wherein in response to an unsuccessful connection, the information handling system is configured to select a different node from the first group.

13. An article of manufacture comprising a non-transitory, computer-readable medium having computer-executable instructions thereon that are executable by a processor of an information handling system for:
selecting a node from a plurality of nodes of an information handling system cluster for establishing secure communication with a backend system by:
partitioning the plurality of nodes into a plurality of groups;
selecting a first group from the plurality of groups;
selecting a node from the first group that includes a connectivity key thereon;
attempting to establish connectivity with the backend system via the connectivity key; and
in response to a successful connection, altering a priority setting associated with the first group.

14. The article of claim 13, wherein the information handling system cluster is a hyper-converged infrastructure (HCI) system.

15. The article of claim 13, wherein the altered priority setting is configured to cause the first group to be preferred in subsequent attempts to establish connectivity with the backend system.

16. The article of claim 13, wherein partitioning the plurality of nodes into the plurality of groups comprises putting an equal number of nodes into each group.

17. The article of claim 13, wherein partitioning the plurality of nodes into the plurality of groups is based at least in part on customized group rules.

18. The article of claim 13, wherein in response to an unsuccessful connection, the information handling system is configured to select a different node from the first group.
